(19) United States
(12) Patent Application Publication
(10) Pub. No.: US 2022/0105611 A1
(43) Pub. Date: Apr. 7, 2022

(54) TORQUE CONTROL TOOL

(71) Applicant: Ingersoll-Rand Industrial U.S., Inc., Davidson, NC (US)

(72) Inventors: Mark T. McClung, Andover, NJ (US); Timothy R. Cooper, Titusville, NJ (US); Warren A. Seith, Bethlehem, PA (US); Douglas E. Pyles, Bethlehem, PA (US)

(21) Appl. No.: 17/064,764

(22) Filed: Oct. 7, 2020

(51) Int. Cl. B25B 23/147; B25B 21/02

(52) U.S. Cl. CPC B25B 23/1475; B25B 21/02

(57) ABSTRACT

A power tool and method of determining torque is provided. The method of determining torque uses the energy output by the drive mechanism and the angle of rotation of the output shaft to estimate torque. The energy is determined by subtracting efficiency losses (or gains) from a nominal energy of the drive mechanism in order to improve the torque estimation.

### BACKGROUND

The present inventions relate to torque tools, and more particularly, to determining a torque applied by a power tool to a fastener.

Torque tools are commonly used in industrial settings to tighten fasteners to a specified torque. However, determining the actual torque applied by a power tool to a fastener can be difficult and inaccurate. Although determining the actual torque applied can be difficult for all power tools, impact wrenches are particularly difficult to accurately determine the actual torque applied to a faster. On the other hand, impact wrenches have several advantages over other torque tools, including a compact size, low tool weight and low cost. Thus, improved techniques for accurately determining the torque applied to a fastener would be desirable.

### SUMMARY

An improved power tool with torque control is described. The power tool estimates torque applied to a fastener by measuring the angle of rotation of the fastener and the energy expended by the tool to rotate the fastener through the angle of rotation. The power tool improves on the torque estimation by considering the efficiency of energy expended by the drive mechanism which may result in less energy (or more) being transferred to the fastener. The invention may also include any other aspect described below in the written description or in the attached drawings and any combinations thereof.

### BRIEF DESCRIPTION OF SEVERAL VIEWS OF THE DRAWINGS

The invention may be more fully understood by reading the following description in conjunction with the drawings, in which:

FIG. 1 is a schematic view of an impact wrench; and

FIG. 2 is a chart showing a relationship between angle of rotation, torque and energy.

### DETAILED DESCRIPTION

Estimating the torque applied to a joint resulting from a fastening operation involving discrete blows may use measurements of the angular position of the joint and the change in angular position of the joint with each blow. This information may be coupled with knowledge of the energy in the impact mechanism before and after the blow. Ideally, if the energy leaving the tool in a given blow is measured, the mean torque multiplied by the change in joint angle will be equal to the energy output. Thus, if both the change in joint angle and the amount of energy leaving the tool during each blow are known, the joint torque can be estimated. That is, for a particular blow, the estimated mean joint torque can be determined from the energy that leaves the tool divided by the change in angular position of the threaded joint. It is noted, however, that other schemes involving assumptions about the joint's torque-versus-angle characteristic can also be used in conjunction with angle and energy measurements to estimate joint torque.

Angular position sensors may be placed on the anvil and on the hammer of an impact wrench to determine changes in angle rotation of the output shaft of the tool during a fastener tightening operation. This allows an approximation of the joint angular position and, via differentiating the hammer angular position, provides an estimate of the hammer angular velocity before and after an impact. The velocity change may then be used to determine the change in energy during an impact. That is, the velocity of the hammer will slow due to the impact force, which represents energy which is transferred from the hammer to the output shaft during the impact.

Various sensors may be used to improve torque estimates. A gyro is one type of sensor that may be used for the purpose of compensating for angular motion of the tool when computing angular rotation of the joint. A gyro may also be used to provide housing velocity information. A sudden change in the housing velocity following an impact indicates energy transfer from the mechanism to the housing. Preferably, this energy should be subtracted from that assumed to be utilized in tightening the joint. Various other sensors may also be used to improve estimates of joint torque based on tracking energy changes in addition to tracking the energy change of the impacting hammer. That is, additional and/or alternative sensors may be used to capture other energy that is lost and not transferred to the joint. For example, thermocouples may be used to measure the temperature of elements of the power tool, and thus, track changes in the thermal energy due to impact. This is particularly valuable for the impacting members themselves, but may also be extended to other parts of the tool as well. Accelerometer signals may also be integrated to determine the velocity of various components, allowing for the determination of energy associated with movement and vibration. Frequency analysis of accelerations may also be used in conjunction with peak values and analytical modal analysis to determine energies in vibratory modes excited by the impacts. Additional position sensors (e.g., angular and linear) may also be used to measure deformation and hence potential energy of tool components. Strain gauges may be used for a similar purpose. Other sensors that may be used include torque transducers, motor encoders/resolvers, and current and voltage probes. While the sensors mentioned above may be used for an improved torque estimation, it is understood that many other sensors may also be used to estimate energy changes. While the improved torque measurement methods herein are particularly useful with discrete energy tools like impact wrenches, it is understood that the energy tracking and angular measurement methods described herein may also be applied to continuous energy delivery tools.

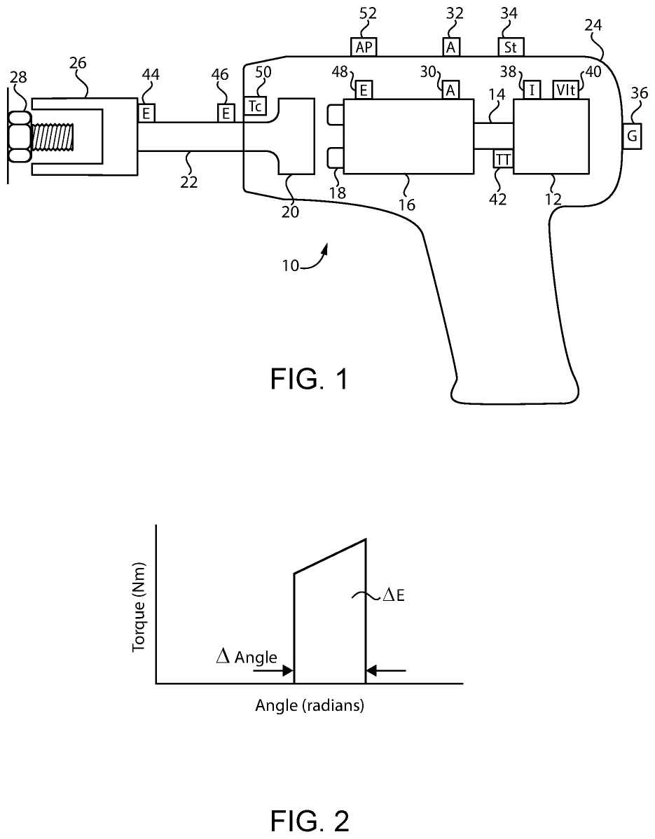

Turning to FIG. 1, a schematic illustration of a power tool 10 is shown. Although it is understood that the inventions herein may be applied to other power tools, the schematic of FIG. 1 relates to an impact wrench 10. As in a conventional impact wrench, the wrench 10 has a motor 12 that rotates a drive shaft 14 which drives an impact drive mechanism 16. It is understood that various types of motors and drive mechanisms may be used. However, in the preferred embodiment, the motor 12 is an electric motor 12, and the drive mechanism 16 is a hammer mechanism 16 with jaws 18 that engage and disengage from an anvil 20 on the proximal end of the output shaft 22. The power tool 10 also includes a tool housing 24 that encloses the motor 12 and drive mechanism 16. A socket 26 may be provided on the distal end of the output shaft 22 to engage the nut 28 of a threaded joint.

As shown in FIG. 2, the torque applied to the nut 28 through the socket 26 may be determined by knowing the angle of rotation of the output shaft 22 during a single impact of the drive mechanism 26 against the output shaft 22, and the energy transferred to the output shaft 22 by the drive mechanism 26 within the angle of rotation. Based on the known angle of rotation and transferred energy, the torque applied to the nut 28 can be determined by the formula:

T=E_{H}/AR

where T is the estimated torque applied to the nut 28, E_{H} is the change in energy of the hammer 16 (that is, drive mechanism 16) before and after an impact, and AR is the angular rotational movement of the nut 28 during the impact. The estimated torque may also be referred to as a residual torque, which is the torque value of the nut 28 or fastener after the power tool 10 has finished tightening the fastener (or at intermediate tightening steps). Preferably, the power tool 10 is provided with a preset torque setting, which may be user adjustable. In use, power to the motor 12 may be switched off when the estimated torque T applied to the nut 28 satisfies the preset torque setting to ensure proper tightening of the nut 28.

Although the above formula may be used as a basic estimate of torque applied to a fastener 28, the formula assumes perfect energy transfer from the drive mechanism 16 to the nut 28 and does not account for the efficiency of such energy transfer. Thus, an improved formula would adjust the energy value based on energy losses (or contributions) that change the actual energy transferred to the nut 28. Thus, the energy value in the above formula may be substituted with an actual energy as determined by the following formula:

E_{Actual}=E_{H}−E_{V}−E_{M}−E_{T}−E_{S}

where E_{Actual} is an estimate of the actual energy transferred to the nut 28 which may be used in the formula above to determine the estimated applied torque, E_{H} is the change in energy of the hammer 16 which may be the same value used in the basic formula above, E_{V} is the energy of tool vibrations associated with an impact, E_{M} is the energy of tool movements during the impact, E_{T} is the energy of temperature changes during impact, and E_{S} is the energy of tool sounds caused by the impact. It is also possible to recharacterize the above formula in terms of efficiency of torque transfer if desired (e.g., with other mathematical operators). For example, the loss in energy (or energy difference) can also be determined by multiplying the hammer energy E_{H} by an efficiency factor. Sensor data from one or more sensors on the tool could be used to determine the efficiency factor for individual blows of the hammer as the tool is operated. For example, using prior testing of the tool, an efficiency correlation between data generated by the sensors and the efficiency factor can be formulated. The efficiency correlation may then be stored on the tool and applied to the sensor data that is generated during tool use to provide the efficiency factor, which can be varied as the tool is being used based on changing sensor data. It is understood that while tool vibrations and tool movements may be related to each other, tool vibrations have a frequency which are typically a multiple of the impact frequency, whereas tool movements may be other tool movements not considered to be vibrations.

Energy estimates may be made for each of the above energy values using a variety of sensors. Therefore, the energy formula above may be rewritten in terms of the sensors that may be used to estimate energy losses (or contributions) to be subtracted from the energy of the hammer 16. Thus, the rewritten formula may be:

E_{Actual}=E_{H}−E_{A}−E_{St}−E_{G}−E_{I}−E_{VIt}−E_{TT}−E_{E}−E_{Tc}−E_{AP}

where E_{Actual} and E_{H} are described above, E_{A} is the energy determined from an accelerometer, E_{St} is the energy determined from a strain gauge, E_{G} is the energy determined from a gyro, E_{I} is the energy determined from a current probe, E_{VIt} is the energy determined from a voltage probe, E_{TT} is the energy determined from a torque transducer, E_{Tc} is the energy determined from a thermocouple, and E_{AP} is the energy determined from an air pressure sensor (e.g., a microphone).

It is understood that the above formulas may be modified as desired for a particular power tool. For example, it is possible to apply a factor to one or more energy values where it is determined that only a portion of the estimated energy associated with a condition or sensor is attributable to an energy loss (or contribution) transferred from the drive mechanism 16 to the output shaft 22. It is also possible that a smaller or greater number of conditions or sensors may be included in the actual energy estimate. Multiple sensors of the same type may also be used in various locations of the power tool 10 to improve the actual energy estimate. Further, multiple sensors may be used together to determine a particular energy estimate.

Examples of sensors that may be used to estimate energy losses (or contributions) are shown in FIG. 1. One sensor that may be used is an accelerometer 30, 32. Accelerometers 30, 32 may be located on the drive mechanism 16 and/or the tool housing 24. The accelerometers 30, 32 may be used to determine vibration energy or movement energy measured on the drive mechanism 16 and/or tool housing 24. Another sensor that may be used is a strain gauge 34. A strain gauge 34 may be located on the tool housing 24 to determine vibration energy or movement energy measured on the tool housing 24. Another sensor that may be used is a gyro 36. A gyro 36 may be located on the tool housing 24 to determine movement energy or vibration energy measured on the tool housing 24. Another sensor that may be used is a current probe 38. A current probe 38 may be electrically connected to the motor 12 to measure the current of the motor 12 which may be used to determine movement energy or vibration energy. Another sensor that may be used is a voltage probe 40. A voltage probe 40 may be electrically connected to the motor 12 to measure the voltage of the motor 12 which may be used to determine movement energy or vibration energy. It is understood that the current probe 38 and voltage probe 40 may also be used together to determine the power of the motor 12 which may also be used to determine movement energy or vibration energy. Another sensor that may be used is a torque transducer 42. A torque transducer 42 may be located on the motor 12 to measure the torque of the motor 12 on the drive shaft 14 or the motor 12 housing in order to determine movement energy or vibration energy. Another sensor that may be used is an encoder 44, 46, 48. Encoders 44, 46, 48 may be located on the output shaft 22 near a distal end, on the output shaft 22 near a proximal end, and/or on the drive mechanism 16. Differences in angular position between any of the encoders 44 may be used to determine movement energy or vibration energy. It is understood that the encoders 44, 46, 48 may also be used to determine the energy of the hammer E_{H} as described above (especially the encoder 48 located on the drive mechanism) and the angular rotation AR described above (especially one of the encoders on the output shaft 44, 46). Another sensor that may be used is a thermocouple 50. A thermocouple 50 may be located adjacent the output shaft 22 (including next to an output shaft bushing) to determine temperature energy. Another sensor that may be used is an air pressure sensor 52. An air pressure sensor 52 (e.g., a microphone 52) may be located on the tool housing 24 to determine sound energy produced by the drive mechanism 16. It is understood that a sensor may be used to determine more than one type of energy (e.g., both a vibration energy and a movement energy) or a single type of energy if desired.

While preferred embodiments of the inventions have been described, it should be understood that the inventions are not so limited, and modifications may be made without departing from the inventions herein. While each embodiment described herein may refer only to certain features and may not specifically refer to every feature described with respect to other embodiments, it should be recognized that the features described herein are interchangeable unless described otherwise, even where no reference is made to a specific feature. It should also be understood that the advantages described above are not necessarily the only advantages of the inventions, and it is not necessarily expected that all of the described advantages will be achieved with every embodiment of the inventions. The scope of the inventions is defined by the appended claims, and all devices and methods that come within the meaning of the claims, either literally or by equivalence, are intended to be embraced therein.

1. A method of controlling a power tool, comprising:
determining an angle of rotation of an output shaft of the power tool in response to a drive mechanism rotating the output shaft;
determining a first energy value of the power tool, the first energy value being a change of energy of the drive mechanism during the angle of rotation;
determining a second energy value of the power tool, the second energy value being an energy of a component of the power tool during the angle of rotation; and
determining a residual torque of a fastener driven by the output shaft based on an energy difference between the first energy value and the second energy value.

2. The method according to claim 1, further comprising switching off an electric motor driving the drive mechanism when the residual torque satisfies a preset torque setting.

3. The method according to claim 1, wherein the first energy value is determined based on a speed difference of the drive mechanism before and after driving the output shaft through the angle of rotation.

4. The method according to claim 1, wherein the power tool is an impact wrench.

5. The method according to claim 1, wherein the second energy value is a tool vibration energy, a tool movement energy, a tool temperature energy or a tool sound energy.

6. The method according to claim 5, wherein the tool vibration energy is determined from an accelerometer, a strain gauge, a gyro, a motor current probe, a motor voltage probe or a torque transducer.

7. The method according to claim 6, wherein the tool vibration energy is determined from the accelerometer, the accelerometer being disposed on a drive mechanism driving the output shaft.

8. The method according to claim 6, wherein the tool vibration energy is determined from the accelerometer, the accelerometer being disposed on a tool housing encompassing a drive mechanism driving the output shaft.

9. The method according to claim 6, wherein the tool vibration energy is determined from the strain gauge, the strain gauge being disposed on a tool housing encompassing a drive mechanism driving the output shaft.

10. The method according to claim 6, wherein the tool vibration energy is determined from the gyro, the gyro being disposed on a tool housing encompassing a drive mechanism driving the output shaft.

11. The method according to claim 6, wherein the tool vibration energy is determined from the motor current probe and/or the motor voltage probe, the motor current probe and/or the motor voltage probe outputting a current and voltage, respectively, of an electric motor driving a drive mechanism which drives the output shaft.

12. The method according to claim 6, wherein the tool vibration energy is determined from the torque transducer, the torque transducer outputting a torque of an electric motor driving a drive mechanism which drives the output shaft.

13. The method according to claim 5, wherein the tool movement energy is determined from an encoder, a gyro, a motor current probe, a motor voltage probe, a torque transducer, an accelerometer or a strain gauge.

14. The method according to claim 13, wherein the tool movement energy is determined from the encoder, the encoder being disposed on the output shaft.

15. The method according to claim 13, wherein the tool movement energy is determined from the gyro, the gyro being disposed on a tool housing encompassing a drive mechanism driving the output shaft.

16. The method according to claim 13, wherein the tool movement energy is determined from the motor current probe and/or the motor voltage probe, the motor current probe and/or the motor voltage probe outputting a current and voltage, respectively, of an electric motor driving a drive mechanism which drives the output shaft.

17. The method according to claim 5, wherein the tool temperature energy is determined from a thermocouple.

18. The method according to claim 17, wherein the thermocouple is disposed adjacent the output shaft.

19. The method according to claim 5, wherein the tool sound energy is determined from an air pressure sensor.

20. The method according to claim 1, wherein the energy difference between the first energy and the second energy is determined by multiplying the first energy value by an efficiency factor, the efficiency factor being determined from sensor data from one or more sensors on the power tool and an efficiency correlation stored on the tool between the sensor data and the efficiency factor.
